(19) United States
(12) Patent Application Publication
(10) Pub. No.: US 2019/0171768 A1
(43) Pub. Date: Jun. 6, 2019

(54) LEVERAGING PAST SEARCH RESULTS WITH CURRENT SEARCH RESULTS

(71) Applicant: MOTOROLA SOLUTIONS, INC, Chicago, IL (US)

(72) Inventors: Anoop Sehgal Paras Ram, IPOH (MY); Hasrolnizam Mohd Mokhtar, TELUK INTAN (MY); Woei Chyuan Tan, BAYAN LEPAS (MY); Chun Meng Tan, BAYAN LEPAS (MY)

(21) Appl. No.: 15/831,447

(22) Filed: Dec. 5, 2017

(51) Int. Cl. G06F 17/30

(52) U.S. Cl. CPC G06F 17/30867; G06F 17/30395

(57) ABSTRACT

A method and apparatus for leveraging past search results is provided herein. During operation a search string/phrase is received from a person and the search string is provided to a search engine. A plurality of search results is received from the search engine. A database of past search results is accessed, and a search result from the plurality of search results is deprioritized if the search result is included in the database of past search results.

### BACKGROUND OF THE INVENTION

Oftentimes a user will perform multiple internet searches within a short period of time because prior searches did not return information that was useful to the user. Many subsequent searches may result previously-provided information again being provided to the user, which causes the user to unnecessarily re-review information. This is illustrated in FIG. 1. As shown, a user searches on the term “Penang what to do” and obtains a first set of results. Uninterested in these results, the user then performs a second search on the term “Penang attractions”, and obtains a second set of results. As is evident, some of the results in the first search are repeated in the second search.

In addition to the above, oftentimes public-safety officers are asked to find information from public-safety databases as part of crime-solving activities. As anyone who has done an internet search knows, online searching for relevant information can be a time consuming process. The man hours spent on investigating a particular incident increases significantly when multiple officers are simultaneously searching for information about a same incident.

During group collaboration, many hours may be wasted by members needlessly reviewing the same information. United States Patent Publication No. 2008/0065600 describes a group collaboration technique. According to this publication, the search results that are relevant to one group member are then prioritized within the search results provided to other group members making similar searches. However, this technique results in users re-reviewing much of the same information, since a first user's search results are prioritized within a second user's search results.

Currently, there is no technique for public safety users to perform internet/database searches on the same incident and leverage on each other's investigation effort so that needless re-reviewing of information is avoided. Such leveraging could significantly increase the efficiency of any internet/database search. Therefore, a need exists for a method and apparatus for searching in a group or non-group setting that leverages past searches so that needless re-reviewing of past search results is minimized.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates prior-art searching.

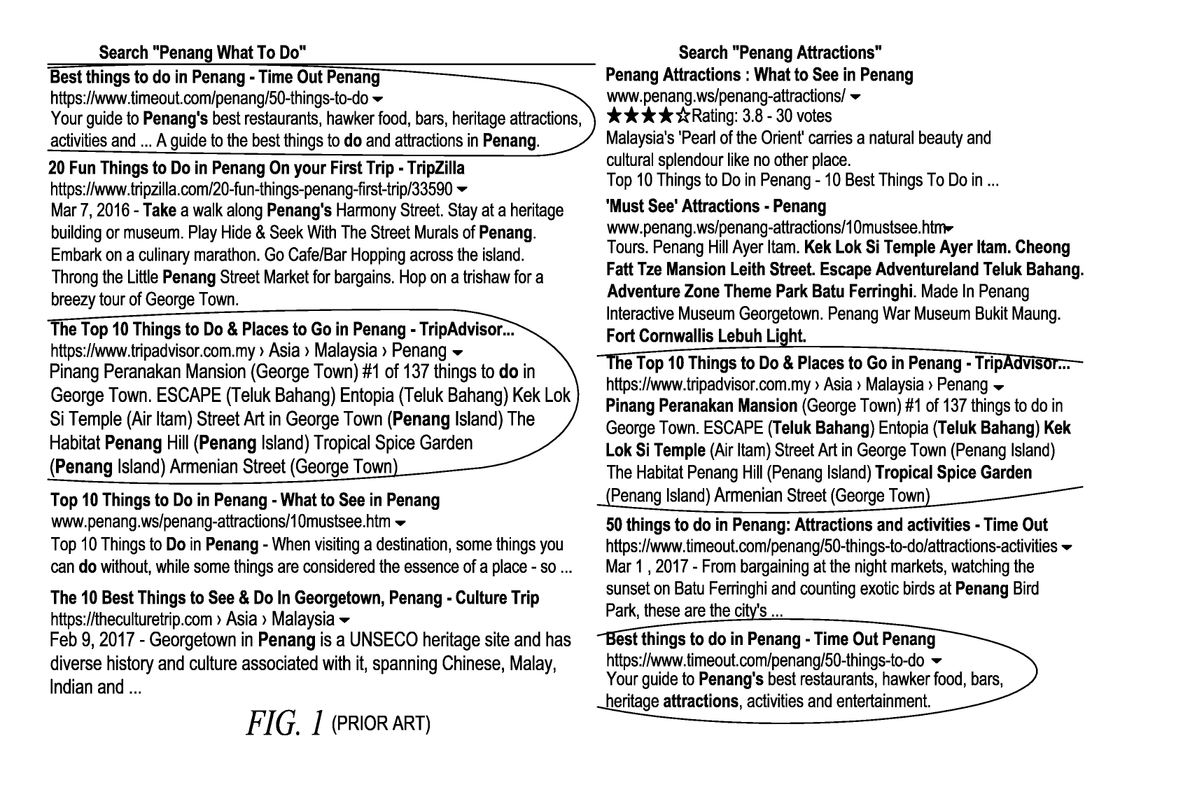

FIG. 2 shows a general operating environment including an apparatus for leveraging past search results when performing a search.

FIG. 3 is a flow chart showing operation of the computer of FIG. 2.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for leveraging past search results is provided herein. During operation a search string/phrase is received from a person and the search string is provided to a search engine. A plurality of search results is received from the search engine. A database of past search results is accessed, and a search result from the plurality of search results is deprioritized if the search result is included in the database of past search results.

Search results can be displayed in a list, wherein the list excludes any deprioritized search result. Alternatively search results can be displayed in a list, wherein the list includes the deprioritized search results, however, the deprioritized search results are displayed after more-relevant search results (i.e., the more relevant search results are displayed first, in for example, a list of search results). Alternatively, search results can be displayed in a list, wherein the list includes the deprioritized search results, however, the deprioritized search results are displayed on another page (2^{nd} page or 3^{rd} page of the results), with more-relevant search results being displayed being displayed on a first page.

Because prior search results will be deprioritized within the current search results, the instances of needless re-reviewing of past search results will be reduced. It should be noted that when multiple users of a group are collaboratively searching a similar subject matter, all members of the group will have their past search results logged/stored in the database. Any subsequent search by a member of the group will have their search results analyzed and potentially de-prioritized as described above, with past search results for the group being used to deprioritize the search results of a single user that is a member of the group.

It should be noted that in both the single-user scenario, and the multi-user scenario, a time of the search (e.g., a time the search was made) may be utilized when deprioritizing search results. For example, in one embodiment of the present invention, a search result is only deprioritized if it matches prior search results, and the current search and the prior search (that produced a similar search result) took place within a predetermined period of time (e.g., 5 minutes). Therefore, if a user performs a first search, and then performs a second search within the predetermined period of time, the first search (returning first search results) will be used to deprioritize second search results from the second search. However, if a user performs a first search, and then performs a second search not within the predetermined period of time, the first search (returning first search results) will not be used to deprioritize second search results from the second search.

In another embodiment, only the most relevant search results are included in the database of past search results, and will be used to deprioritize future search results. For example, assume a first internet search resulted in 100 web pages being returned. The 100 web pages will be ranked in order of relevance. Only the N-most relevant web pages (e.g., 10 most-relevant web pages) will be added to the database of past search results and used to deprioritize future search results.

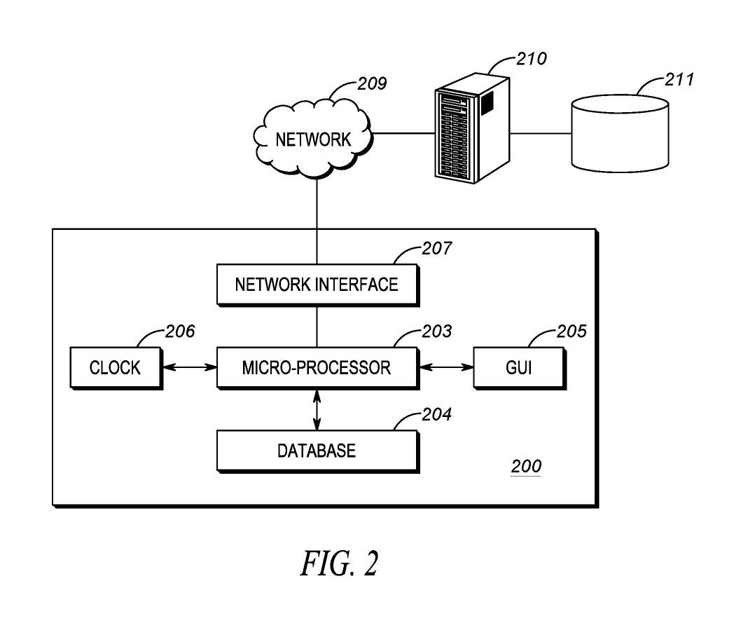

Turning now to the drawings wherein like numerals designate like components, FIG. 2 shows a general operating environment for the present invention. The operating environment includes computer 200. In a preferred embodiment of the present invention, computer 200 serves as a device for deprioritizing search results as described above. Server 210 serves as a search engine and performs searching of database 211 as is commonly known in the art. Server 210 may comprise a commercial search server such as, but not limited to Google®, Yahoo®, Amazon®, . . . , etc. Alternatively, server may comprise a proprietary, internal server that performs searching on internal databases.

As shown server 210 is coupled to database 211. Database 211 comprises information to be searched. For example, database 211 may comprise web site addresses and content, crime history, department of motor vehicle (DMV) data, . . . , etc. It should be noted that although only one server 210 is shown coupled to database 211, there may exist many servers 210 providing searching capabilities, with each server 210 having its own database 211.

In one embodiment of the present invention, server 210 is shown as a separate entity from computer 200. When server 210 lies external to computer 200, communication between computer 200 and server 210 takes place through an intervening network 209. In an alternate embodiment of the present invention, server 210 may exist within computer 200.

As shown, computer 200 may include logic circuitry 203, memory 204, GUI 205, clock 206, and network interface 207. In other implementations, computer 200 may include more, fewer, or different components.

Logic circuitry 203 comprises a digital signal processor (DSP), general purpose microprocessor, a programmable logic device, or application specific integrated circuit (ASIC) and is utilized for providing a search string to a search engine and receiving a plurality of search results from the search engine. Logic circuitry 203 is also utilized for deprioritizing a search result from a plurality of search results if the search result is included in the past search results.

Network interface 207 includes elements including processing, modulating, and transceiver elements that are operable in accordance with any one or more standard or proprietary wireless interfaces, wherein some of the functionality of the processing, modulating, and transceiver elements may be performed by means of the processing device 203 through programmed logic such as software applications or firmware stored on the storage component 204 (standard random access memory) or through hardware. Examples of network interfaces (wired or wireless) include Ethernet, T1, USB interfaces, IEEE 802.11b, IEEE 802.11g, etc.

Memory 204 comprises standard random-access memory, and is used to store past search results. Memory 204 may be purged of past search results that are older than a predetermined threshold. Purging memory 204 of search results older than a predetermined threshold will serve to prevent de-prioritization of current search results if the current search and past searches do not take place within a predetermined amount of time.

Graphical user interface (GUI) 205 provides a man/machine interface for receiving an input (e.g., a search string) from a user and displaying information (e.g., modified search results). For example, GUI 205 may provide a way of conveying (e.g., displaying) information received from processor 203. Part of this information may comprise modified search results. In order to provide the above features (and additional features), GUI 205 may comprise any combination of a touch screen, a computer screen, a keyboard, and/or any other interface needed to receive a user input and provide information to the user.

Finally, clock 206 comprises timing circuitry in order to determine a time of a search. When logic circuitry 203 stores past search results, a time of the search may be included in this information. Alternatively, logic circuitry 203 may access clock 206 to determine a current time, and then purge all search results from database 204 if they are older than a predetermined threshold.

During operation, GUI 205 receives a user identification (ID) and/or a group ID along with a search string from a user. The search string and any ID are passed to logic circuitry 203 which forwards the search string to server 210 via interface 207/network 209. In response, search results are received at interface 207 and forwarded to logic circuitry 203. Logic circuitry 203 stores at least a portion of the search results within database 204 with the corresponding ID and a time of the search.

As discussed above, logic circuitry will deprioritize some of the current search results if they are included in database 204 and associated with the received ID. More particularly, a plurality of search results is received by logic circuitry 203 from search engine 210. Database of past search results 204 is accessed, and a search result from the plurality of search results is deprioritized if the search result is included in the database of past search results (and associated with the user/group ID).

The modified search results are then sent to GUI 205 to be displayed, for example, in a list, wherein the list excludes any deprioritized search result. Alternatively search results can be displayed in a list, wherein the list includes the deprioritized search results, however, the deprioritized search results are displayed after more-relevant search results (i.e., the more relevant search results are displayed first, in for example, a list of search results). Alternatively, search results can be displayed in a list, wherein the list includes the deprioritized search results, however, the deprioritized search results are displayed on another page (2^{nd} page or 3^{rd} page of the results), with more-relevant search results being displayed being displayed on a first page.

Because prior search results will be deprioritized within the current search results, the instances of needless re-reviewing of past search results will be reduced. It should be noted that when multiple users of a group are collaboratively searching a similar subject matter, all members of the group will have their past search results logged/stored in the database. Any subsequent search by a member of the group will have their search results analyzed and potentially de-prioritized as described above by using past search results of the group.

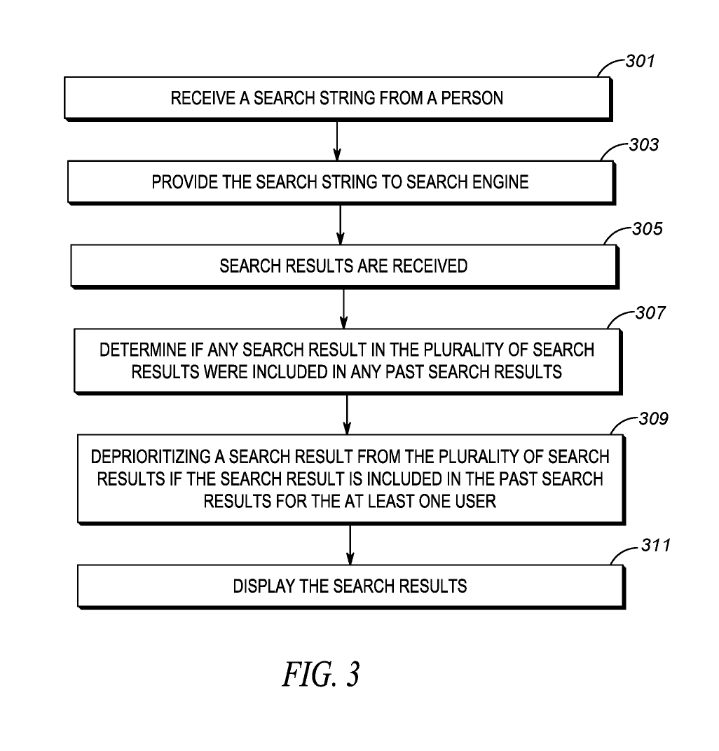

FIG. 3 is a flow chart showing operation of the computer of FIG. 2. 1. The logic flow begins at step 301 where user interface 205 receives a search string from a person and provides the search string to logic circuitry 203. At step 303 logic circuitry receives the search string and provides the search string to search engine 210. A plurality of search results is received by logic circuitry 203 from the search engine (step 305). At step 307 logic circuitry 203 accesses database 204 to determine if any search result in the plurality of search results were included in any past search results. At step 309, logic circuitry modifies the plurality of search results by deprioritizing a search result from the plurality of search results if the search result is included in the past search results for the at least one user. Finally, at step 311 logic circuitry sends the modified search results to GUI 205 to display the search results.

As discussed above, the search results may be displayed in a list, wherein the list excludes the deprioritized search result, or alternatively includes the deprioritized search result, however, the deprioritized search result is displayed further down the list than more-prioritized search results.

As discussed above, the technique described above can be applied in a single-user scenario wherein the person and the at least one user are the same individual. Alternatively, the technique described above can be applied in a group scenario where the person and the at least one user are different individuals.

It should be noted that database 204 will preferably contain past search results for multiple people and multiple groups of people. Because of this, one may wish to limit the data stored in database 204. One way to limit the data stored in database 204 is to store only past search results that were interacted with by the at least one user. So for example, only search result links that were “clicked” and/or followed/viewed may be stored. Alternatively, only the most-relevant N results of any search may be stored, so for example, if a search returned 100 results, only the 10 most-relevant results may be stored in database 204.

Another way to limit the amount of data in database 204 is to periodically purge database 204 of past search results if the past search results are older than a predetermined threshold (e.g., 1 day). Doing this will have the effect of deprioritizing any search result from the plurality of search results if the search result and the past search results were obtained within a predetermined period of time. In order to accomplish this task, timing circuitry (e.g., clock) 206 may be provided and coupled to logic circuitry 203.

Whether or not database 204 is periodically purged or not, it still may be desirable to deprioritize a current search result only if the current search result and the stored search result match, and the current search result and the stored search result were obtained within a predetermined period of time. This will serve to deprioritize search results only when searches are made relatively close in time to each other (e.g., within 1 minute, 10 seconds, . . . , etc.).

It should also be noted that because database 204 will be storing search results from multiple groups/individuals, the past search results stored in database 204 will need to be associated with a particular group or individual. In this way, when an individual is searching not as part of a group, the individual does not have their search results effected by any other individual's past searches. Similarly, when an individual is searching as part of a group, the individual does not have their search results effected by any other group's past searches.

With the above in mind, GUI 205 may additionally receive a group and/or user identification as part of the search string and supply this to logic circuitry 203. Logic circuitry 203 will additionally deprioritizes the search result from the plurality of search results if the person and the at least one user are members of a same group identified by the group identification, or the same person identified by the same user ID.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus comprising:
a user interface receiving a search string from a person;
logic circuitry providing the search string to a search engine and receiving a plurality of search results from the search engine;
a database comprising past search results for at least one user;
the logic circuitry deprioritizing a search result from the plurality of search results if the search result is included in the past search results for the at least one user; and
a display, displaying the search results.

2. The apparatus of claim 1 wherein the search results are displayed in a list, wherein the list excludes the deprioritized search result.

3. The apparatus of claim 1 wherein the person and the at least one user are the same individual.

4. The apparatus of claim 1 wherein the person and the at least one user are different individuals.

5. The apparatus of claim 1 wherein the past search results comprise only past search results that were interacted with by the at least one user.

6. The apparatus of claim 1 further comprising:
timing circuitry; and
wherein the logic circuitry additionally deprioritizes the search result from the plurality of search results if the search result and the past search results were obtained within a predetermined period of time.

7. The apparatus of claim 1 wherein:
the user interface additionally receives a group identification; and
the logic circuitry additionally deprioritizes the search result from the plurality of search results if the person and the at least one user are members of a same group identified by the group identification.

8. An apparatus comprising:
a user interface receiving a search string from a first person;
logic circuitry providing the search string to a search engine and receiving a plurality of search results from the search engine;
a database comprising past search results for a second person;
the logic circuitry deprioritizing a search result from the plurality of search results if the search result is included in the past search results for the second person and if the search result and the past search results were obtained within a predetermined period of time; and
a display, displaying the search results in a list, wherein the list excludes the deprioritized search result.

9. A method comprising the steps of:
receiving by a user interface, a search string from a person;
providing via logic circuitry, the search string to a search engine and receiving a plurality of search results from the search engine, and modifying the plurality of search results by deprioritizing a search result from the plurality of search results if the search result is included in the past search results for at least one user; and
displaying the search results.

10. The method of claim 9 wherein the search results are displayed in a list, wherein the list excludes the deprioritized search result.

11. The method of claim 9 wherein the person and the at least one user are the same individual.

12. The method of claim 9 wherein the person and the at least one user are different individuals.

13. The method of claim 9 wherein the past search results comprise only past search results that were interacted with by the at least one user.

14. The method of claim 9 further comprising the step of:
deprioritizing the search result from the plurality of search results if the search result and the past search results were obtained within a predetermined period of time.

15. The method of claim 9 further comprising the steps of:
receiving a group identification; and
deprioritizing the search result from the plurality of search results if the person and the at least one user are members of a same group identified by the group identification.
